(19) United States
(12) Patent Application Publication
(10) Pub. No.: US 2018/0279250 A1
(43) Pub. Date: Sep. 27, 2018

(54) METHOD AND/OR SYSTEM FOR POSITIONING FROM A REFERENCE SIGNAL

(71) Applicant: QUALCOMM Incorporated, San Diego, CA (US)

(72) Inventors: Arun Kumar Sharma Tandra, Hyderabad (IN); Ashwin Kumar Donthula, Hyderabad (IN)

(21) Appl. No.: 15/470,320

(22) Filed: Mar. 27, 2017

(51) Int. Cl. H04W 64/00

(52) U.S. Cl. CPC H04W 64/00; H04W 88/02

(57) ABSTRACT

Techniques are provided that provide for or otherwise support positioning and related services for mobile devices via wireless signals. In an example, a mobile device may receive from a location server one or more messages comprising positioning assistance data indicating at least an operating frequency band of a terrestrial positioning signal (TPS). Responsive to detecting an incompatibility of an operating frequency band of the TPS with an operating frequency band of a receiver of the mobile device, the mobile device may initiate an alternative signal acquisition process.

### BACKGROUND

### Field

Subject matter disclosed herein relates to location estimation at a mobile device.

### Information

The location of a mobile device, such as a cellular telephone, may be estimated based on information gathered from various systems. In a cellular network implemented according to Long-Term Evolution (LTE), for example, a base station may transmit a positioning reference signal (PRS). A mobile device acquiring a positioning reference signals (PRSs) transmitted by different base stations may deliver signal-based measurements to a location server for use in computing an estimate of a location of the mobile device using observed time difference of arrival (OTDOA) techniques. Alternatively, a mobile device may also compute an estimate of its location using OTDOA techniques.

### SUMMARY

Briefly, a particular implementation is directed to a method, at a mobile device, comprising: obtaining, one or more messages received from a location server, assistance data indicating at least an operating frequency band of a terrestrial positioning signal (TPS); and initiating an alternative signal acquisition process at a receiver of the mobile device, the receiver of the mobile device having an operating frequency band narrower than the operating frequency band of the TPS, in response to a determination that the operating frequency band of the TPS is unsuitable for application of the TPS in performing a positioning operation.

Another particular implementation is directed to a mobile device comprising: a receiver; and one or more processors coupled to the receiver and configured to: obtain from one or more messages received at the receiver positioning assistance data indicating at least an operating frequency band of a terrestrial positioning signal (TPS); and initiate an alternative signal acquisition process at the receiver, the receiver having an operating frequency band narrower than the operating frequency band of the TPS, in response to a determination that the operating frequency band of the TPS is unsuitable for application of the TPS in performing a positioning operation.

Another particular implementation is directed to a storage medium comprising computer-readable instructions stored thereon which are executable by a processor of a mobile device to: obtain, from one or more messages received from a location server, assistance data indicating at least an operating frequency band of a terrestrial positioning signal (TPS); and initiate an alternative signal acquisition process at a receiver of the mobile device, the receiver of the mobile device having an operating frequency band narrower than the operating frequency band of the TPS, in response to a determination that the operating frequency band of the TPS is unsuitable for application of the TPS in performing a positioning operation.

Another particular implementation is directed to a mobile device comprising: means for receiving, from a location server, one or more messages comprising positioning assistance data indicating at least an operating frequency band of a terrestrial positioning signal (TPS); and means for initiating an alternative signal acquisition process at a receiver of the mobile device, the receiver of the mobile device having an operating frequency band narrower than the operating frequency band of the TPS, in response to a determination that the operating frequency band of the TPS is unsuitable for application of the TPS in performing a positioning operation.

It should be understood that the aforementioned implementations are merely example implementations, and that claimed subject matter is not necessarily limited to any particular aspect of these example implementations.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a system diagram illustrating certain features of a system comprising a mobile device, in accordance with an example implementation;

FIG. 2 is a timeline of a signal, in accordance with an example implementation;

FIG. 3 is a table illustrating aspects of a terrestrial positioning signal in some aspects;

FIG. 4A is a flow diagram of a process according to an embodiment;

FIG. 4B is a flow diagram of a process for initiating an alternative signal acquisition process;

FIG. 5 is a schematic block diagram depicting an example wireless communication system including a plurality of computing platforms comprising one or more wirelessly connected devices, in accordance with an implementation;

FIG. 6 is a schematic block diagram of a mobile device, in accordance with an example implementation; and

FIG. 7 is a schematic block diagram of an example computing platform in accordance with an implementation.

Reference is made in the following detailed description to accompanying drawings, which form a part hereof, wherein like numerals may designate like parts throughout that are identical, similar and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like mean that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. However, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

The Global Positioning System (GPS), and other like satellite positioning systems (SPSs), have enabled navigation receivers on mobile devices to process signals from transmitters aboard space vehicles (“SPS signals”) to obtain location estimates and/or navigation solutions. For example, by processing SPS signals to obtain pseudorange measurements to four or more measuring transmitters at known locations, a mobile device may estimate its location using well known techniques.

The position of a mobile device may also be estimated based on terrestrial positioning signals received and processed at the mobile device. In a cellular network implemented according to 4.0 G Long-Term Evolution (LTE), for example, a base station may transmit a positioning reference signal (PRS). A mobile device acquiring a PRS transmitted by three different base stations may deliver measurements to a location server for use in computing an estimate of the mobile device location using observed time difference of arrival (OTDOA) techniques. Alternatively, the mobile device may also compute an estimate of its location based on measurements obtained at the mobile device using OTDOA techniques.

According to an embodiment, a carrier deploying an LTE network may be required by regulators to provide an E911 service capable of furnishing estimated locations of mobile devices to emergency responders. To implement an E911 service, a carrier operator may deploy one or more location servers to, for example, provide current and accurate estimated locations of subscriber mobile devices to emergency responders. To a enable a mobile device to obtain an OTDOA position fix in support of an E911 service, a location server may provide subscriber mobile devices with positioning assistance data listing several cells (e.g., base station transceivers) which may be capable of transmitting a PRS. The positioning assistance data may further comprise parameters indicative of one or more PRS configurations including, for example, a PRS bandwidth, a PRS configuration index, a number of successive subframes or a PRS muting pattern, or a combination thereof, just to list a few examples. These parameters indicative of one or more PRS configurations may be incorporated into positioning assistance data to enable efficient search for and acquisition of PRS' by client devices.

LTE OTDOA may allow for inter-frequency OTDOA including reference signal time difference (RSTD) measurements based on PRS' acquired at different channels. As such, a mobile device may be configurable to tune away to make OTDOA measurements on PRSs transmitted on multiple different frequency channels. Similar mechanisms may be used to measure any newly defined PRS configurations. Some systems may specify a mobile device to be tuned to an air interface/frequency channel, permitting a fully integrated solution where a PRS may be transmitted in band, out of band, or both to achieve a desired level of performance.

OTDOA measurements from acquisition of PRS in an LTE network may support applications other than providing responses to E911 events. For example, OTDOA measurements from acquisition of PRS in an LTE network may support navigation or social media applications. Also, low-power “Internet of Things” (IoT) may comprise receivers configured for processing LTE signals, and in particular, a PRS to facilitate positioning operations. North American LTE operators, for example, are planning to deploy solutions to service Cat M1 devices employing a narrowband receiver of only about 1.4 MHz, but may operate within an LTE carrier environment of up to a 20 MHz operational bandwidth.

In certain scenarios, particular features of a PRS configuration available to a mobile device, such as a Cat M1 device, may be incompatible with the mobile device. For example, an operational frequency band of a receiver of the mobile device may not overlap with the transmission band of the PRS. In another scenario, a duty cycle of the PRS may be so low that, in combination with a narrow operational frequency band of a receiver of the mobile device, the receiver may not have an opportunity to integrate sufficient signal energy for a reliable detection and determination of an RSTD measurement.

According to an embodiment, a mobile device may receive one or more messages from a location server including, among other things, parameters characterizing a PRS transmitted in a coverage area. Such parameters may indicate, for example, a transmission band of the PRS and a duty cycle of the PRS. The mobile device may determine an incompatibility of the PRS and a receiver of the mobile device based, at least in part, on the PRS parameters of the positioning assistance data. In one example incompatibility, the mobile device may determine that the operational bandwidth at which the receiver device is configured does not overlap with the transmission band of the PRS. In another example incompatibility, the mobile device may determine that, based on the operational bandwidth at which the receiver device is configured and a duty cycle of the PRS, the receiver device may not be able to integrate sufficient signal energy at the operational bandwidth for a reliable detection.

In response to detection of one of the aforementioned incompatibilities, according to an embodiment, a mobile device may commence frequency hopping. For example, a mobile device having a configured operational bandwidth that does not overlap with the transmission band of a PRS may employ frequency hopping to detect/integrate signal energy of the transmission band of the PRS. Also, if a duty cycle and transmission band of a PRS does not permit reliable detection of the PRS at an operation bandwidth of a receiver of a mobile device, the mobile device may employ frequency hopping to detect different portions of the PRS at different frequencies, thereby permitting cancellation of noise that is uncorrelated in frequency for improved signal detection. Following obtaining RSTD measurements through frequency hopping (responsive to detection of an incompatibility), a mobile device may return operation of a receiver to an original configuration at an allocated operational frequency band.

In an alternative implementation, in response to detection of one of the aforementioned incompatibilities, a mobile device may tune a receiver to acquire a signal other than a PRS. For example, in response to detection of one of the aforementioned incompatibilities, a mobile device may tune a receiver to acquire a cell-specific reference signal (CRS) and/or an LTE synchronization signal (e.g., a primary synchronization signal (PSS) or secondary synchronization signal (SSS)) in lieu of acquiring a PRS.

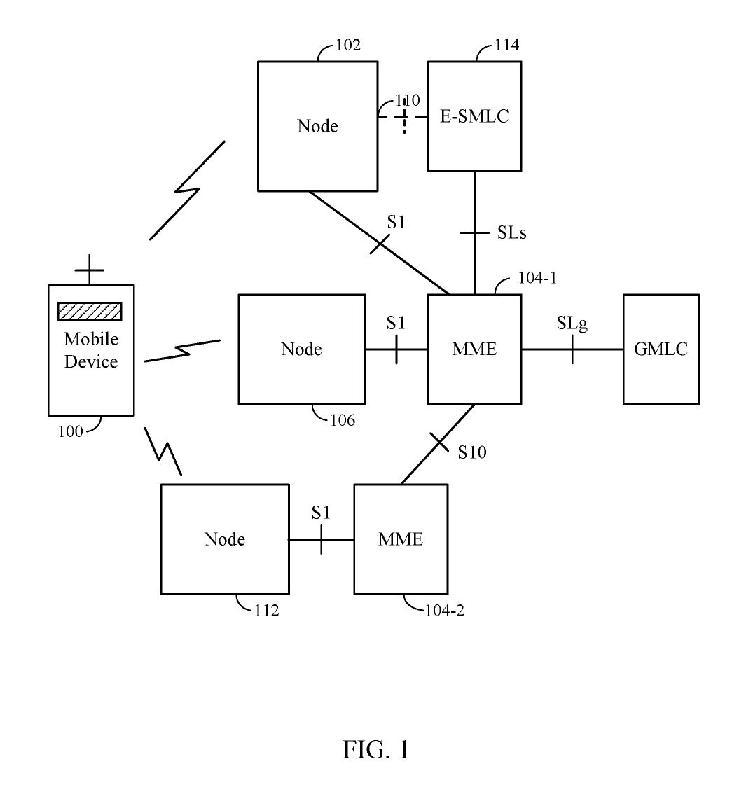

FIG. 1 is a schematic diagram showing a topology of an example cellular/wireless communications network according to an embodiment. The particular implementation shown in FIG. 1 is directed to an LTE network but features may similarly be implemented in other types of cellular/wireless networks without deviating from claimed subject matter. In an example scenario, mobile device 100 may access service (e.g., voice, data, positioning, etc.) through node 106 (e.g., via an LTE Uu interface). As shown, nodes 102, 106 and 112 are connected to corresponding mobility management entities (MMEs) 104 through S1 interfaces.

In particular implementations, mobile device 100 may acquire a PRS (or, alternatively a CRS or synchronization signal) transmitted by one or more nodes 102, 106 or 112 for use in positioning operations (e.g., to compute an estimated location using OTDOA techniques). For example, mobile device 100 may acquire a PRS signal transmitted by three eNodeB devices (e.g., at nodes 102, 106 or 112) to obtain a reference signal time difference (RSTD) measurement.

In particular implementations, an eNode B device (e.g., node 102, 106 or 112) may exchange messages with a location server such as represented here by an enhanced serving mobile location center (E-SMLC) 114, possibly over an LPPa signaling transport (see, e.g., 3GPP TS 36.45) via an MME 104, for example. Using an LPPa signaling transport in an uplink direction, for example, E-SMLC 114 may obtain from an eNode B device parameters defining properties of a PRS (or other terrestrial positioning signal) to be transmitted to UEs as the OTDOA assistance data via another protocol such as LPP (LTE Positioning Protocol; see, e.g., 3GPP TS 36.355). In an implementation, these parameters defining a configuration of a PRS to be transmitted (e.g., as provided in OTDOA assistance data) may include, for example, bandwidth (BW), configuration index (I_{PRS}, which may then define offset (Δ_{PRS}) and periodicity (T_{PRS})), cyclic prefix length, number of antenna ports, SFN initialization time, burst or pulse duration (N_{PRS}), muting pattern, and muting sequence periodicity (T_{REP}), just to provide a few examples. Using an LPPa signaling transport in an uplink direction, E-SMLC 114 may also obtain from an eNode B device the Enhanced Cell ID (ECID) measurements such as cell identity, Angle of Arrival (AoA), Timing Advance type 1 and type 2, Reference Signal Received Power (RSRP) and Reference Signal Received Quality (RSRQ), just to name a few examples.

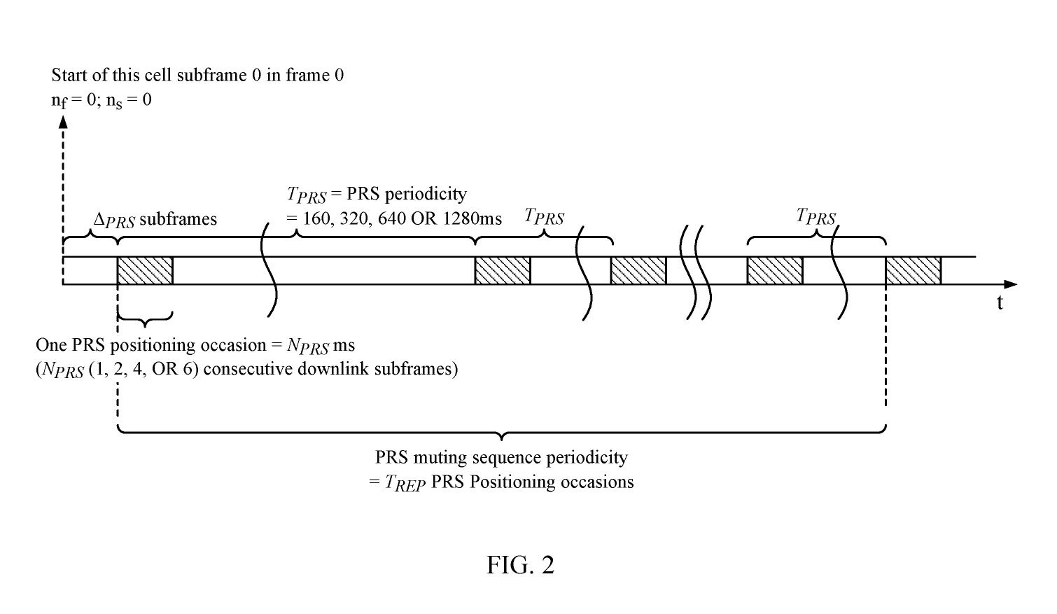

As illustrated in FIG. 2, particular transmission of a PRS may be defined by BW, configuration index (I_{PRS}, which then defines offset (Δ_{PRS}) and periodicity (T_{PRS})), burst or pulse duration (N_{PRS}), muting pattern, and muting sequence periodicity (T_{REP}). As may be observed, a value for T_{PRS} (e.g., 160.0 ms, 320.0 ms, 640.0 ms or 1280.0 ms) and a value for N_{PRS} (e.g., 1.0 ms, 2.0 ms, 4.0 ms or 6.0 ms) may determine a “duty cycle” for a PRS in a PRS subframe. Furthermore, a duty cycle of a PRS in combination with a BW parameter may determine a level of energy of a PRS transmitted over a PRS subframe that may be received by a mobile device to search for and acquire the PRS.

According to an embodiment, overhead of a PRS (PRS_{OVH}) may be computed according to expression (1) as follows:

PRS_{OVH}=N_{PRS}*BW_{PRS}/T_{PRS}*BW_{SYS}, (1)

where:

BW_{SYS} is a system bandwidth of a transmitted downlink signal; and

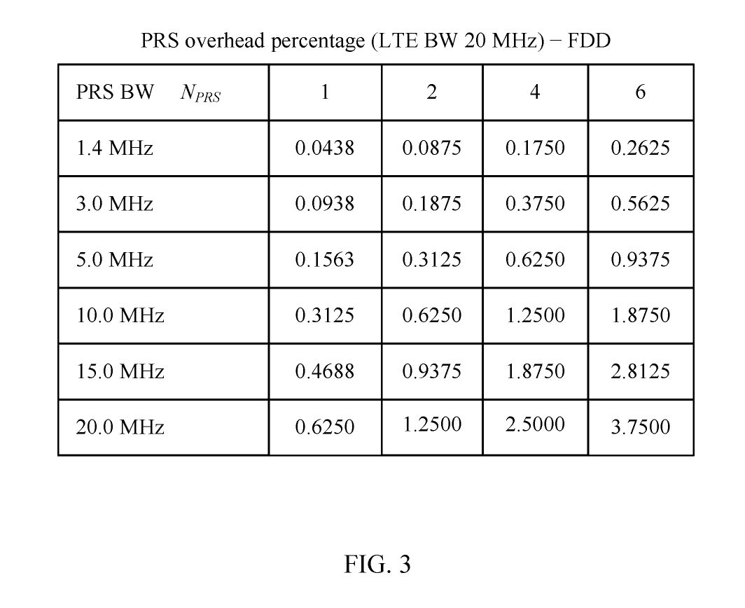

BW_{PRS} is a bandwidth of a PRS transmitted in the downlink signal. Example values for PRS_{OVH} for a system BW_{SYS} are shown in the table of FIG. 3. As shown, a highest value for PRS_{OVH} is 3.7500% for PRS_{BW}=20.0 MHz and N_{PRS}=6.0 ms, and lowest value for PRS_{OVH} is 0.0438% for PRS_{BW}=1.4 MHz and N_{PRS}=1.0 ms.

In particular implementations as discussed above, node 102, 106 and/or 112 may comprise a controller or processor capable of tailoring transmission of a PRS at a high or full duty cycle by affecting parameters T_{PRS} and/or N_{PRS}. In one implementation, parameters T_{PRS} and/or N_{PRS} may be varied in response to demand for downlink signal resources (e.g., to provide voice or data services).

As pointed out above, some implementations of mobile device 100 may comprise devices configured to receive downlink signals in a narrow operating band. For example, eNode B devices may be configured to schedule or allocate 1.4 MHz of a system bandwidth of a downlink signal for service to so-called Cat M1 devices. Accordingly, a receiver at a Cat M1 device may be configured to process a downlink signal over such an allocated narrowband 1.4 MHz portion of a system bandwidth for receipt of messages and/or positioning operations (e.g., acquisition of a PRS in the downlink signal). Unfortunately, a device configured to process downlink signals over a narrow frequency band (e.g., a Cat M1 device) may not be capable of reliably acquiring a PRS in a downlink signal under certain conditions. In one scenario, a PRS may be transmitted in a downlink signal at a particular frequency band that does not substantially overlap an operating frequency band of a device configured to process downlink signals over a narrow frequency band.

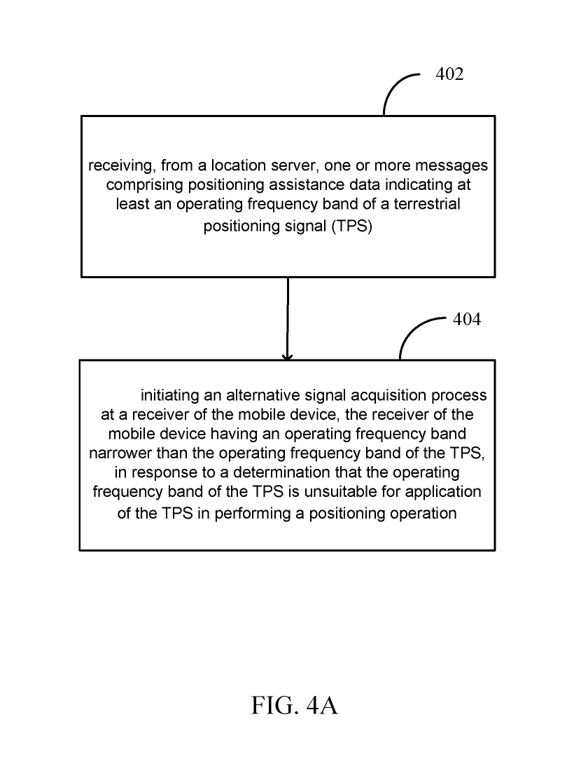

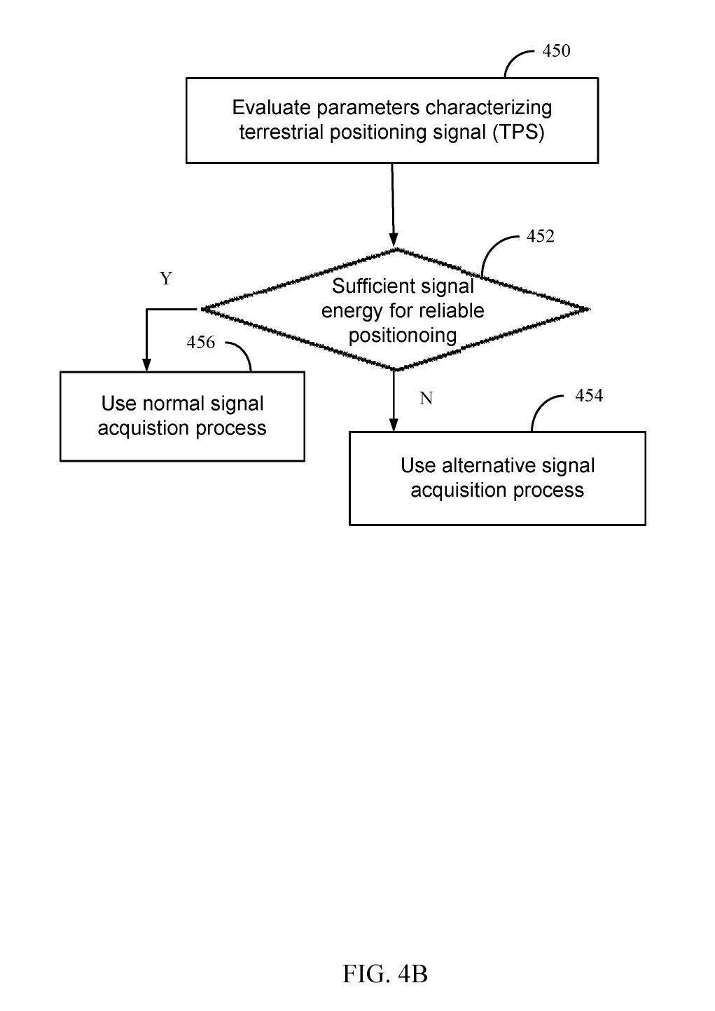

In another scenario, a device configured to process downlink signals over a narrow frequency band may not be capable of reliably acquiring a PRS transmitted in a downlink signal with particular combinations of N_{PRS} and system bandwidth PRS_{BW} for lack of available received signal energy. Referring the to the particular example of FIG. 3, a device configured to process downlink signals over a narrow frequency band may not be capable of reliably acquiring a PRS transmitted with the combinations of PRS_{BW}=1.4 or 3.0 MHz and N_{PRS}=1.0, 2.0 or 4.0 ms, or PRS_{BW}=5.0 MHz and N_{PRS}=1.0. On the other hand, a device configured to process downlink signals over a narrow frequency band may reliably acquire a PRS having sufficient signal power/energy such as a PRS transmitted with the combinations of PRS_{BW}=5.0 MHz and N_{PRS}=4.0 or 5.0 ms, or PRS_{BW}=10.0, 15.0 or 20.0 MHz and N_{PRS}=2.0, 4.0 or 6.0 ms. FIG. 4 is a flow diagram of a process for acquiring a terrestrial positioning signal according to an embodiment. In a particular implementation, actions shown in blocks 402, 404 and 406 may be performed, at least in part, by a mobile device such as mobile device 100. For example, actions shown in blocks 402, 404 and 406 may be performed by a mobile device configured to process a downlink signal over an allocated narrowband operating frequency band of a downlink signal.

Block 402 comprises obtaining positioning assistance data at a mobile device indicating at least an operating band of a terrestrial positioning signal (TPS). In this context, a “TPS” as referred to herein means a signal transmitted from a ground-based transmitter of a first device that may be observed by a second device for obtaining one or more parameters indicative of a location of the second device. Such a TPS may comprise a PRS transmitted by an eNode B device. It should be understood, however, that a PRS is merely one example of a TPS, and claimed subject matter is not limited in this respect. In particular example, implementations, a TPS may comprise a signal having purposes or uses other than positioning operations. For example, a TPS may also comprise a pilot signal, cell-specific reference signal (CRS) or a synchronization signal provided to aid in detection of decoding symbols in a message, just to provide a few examples. Positioning assistance data obtained at block 402 may include parameters characterizing a PRS transmitted by a particular eNode B such as, for example, PRS bandwidth PRS_{BW}, configuration index I_{PRS} (which may then define offset (Δ_{PRS}) and periodicity (T_{PRS})), cyclic prefix length, number of antenna ports, SFN initialization time, burst or pulse duration (N_{PRS}), muting pattern, and muting sequence periodicity (T_{REP}) as discussed above. In an example implementation, block 402 may comprise receiving one or more messages from a location server comprising the positioning assistance data including one or more of the aforementioned parameters characterizing a PRS. However, this is merely an example of how a device may obtain position assistance data, and claimed subject matter is not limited in this respect.

As discussed above, in connection with particular embodiments, an operating frequency band of a receiver of a mobile device may be narrower than an operating frequency band of a TPS. In this context, an “operating frequency band of a receiver” means a frequency band bounded by an upper frequency and a lower frequency in which the receiver is configured to process signal energy, to the exclusion substantially of signal energy having a frequency below the lower frequency and of signal energy having a frequency above the higher frequency. Further in this context, an “operating frequency band of a TPS” as referred to herein means a frequency band (e.g., having a lower frequency band and a higher frequency band) allocated for the transmission of signal energy modulated according to particular parameters. Further as discussed above, an operating frequency band of a receiver of a mobile device may be smaller or narrower than a frequency band of a TPS where a frequency band bounded by upper and lower bounds of an operating frequency band of the from a transmitter. For example, an operating frequency band of receiver may be smaller or narrower than an operating frequency band of a TPS if a difference between upper and lower bounds of the operating frequency band of the receiver is less than a difference between upper and lower frequency bands of the operating frequency band of the TPS. Referring to a particular non-limiting example above, a 1.4 MHz operating frequency band of a receiver of a Cat M1 device is smaller or narrower than a PRS having an operating bandwidth of 5.0 MHz.

Block 404 comprises initiating an alternative signal acquisition process at a receiver of the mobile device having an operating frequency band narrower than the operating frequency band of the TPS. Here, block 404 may initiate the alternative signal acquisition process in response to a determination that the operating frequency band of the TPS is unsuitable for application of the TPS in performing a positioning operation based, at least in part, on the operating frequency band of the receiver of the mobile device. In this context, an operating frequency band of a TPS may be determined to be “unsuitable” for application of the TPS in performing a positioning operation as referred to herein means a condition that suggests an unsuitable performance in processing the TPS to perform the positioning operation. For example, an operating frequency band of a TPS may be determined to be unsuitable for application if there is an absence of sufficient overlap between the operating frequency band of the receiver of the mobile device and the operating frequency band of the PRS. In a particular implementation, block 404 may comprise evaluating an allocated bandwidth of a receiver of a mobile device (e.g., a particular 1.4 MHz receiver bandwidth allocated to a Cat M1 device) with an operational bandwidth of the PRS (BW_{PRS}) to determine whether the allocated bandwidth sufficiently overlaps BW_{PRS}. For example, such an unsuitability may comprise a very small overlap or no overlap at all. In another example, an unsuitability for application of a TPS in performing a positioning operation may comprise an operating band of a receiver of a mobile device that is less than an operating frequency band of a TPS (e.g., an operating frequency band of a TPS is selected from 10.0 MHz or 20.0 MHz and an operating frequency band of a receiver of a mobile device is 1.4 MHz).

Another example of an unsuitability of an operating frequency band of a TPS for application of the TPS in performing a positioning operation may comprise a duty cycle of the TPS (e.g., duty cycle of a PRS that is based on values for T_{PRS} and N_{PRS}). Block 404 may also comprise evaluating a duty cycle of a PRS (e.g., evaluating PRS overhead PRS_{OVH} according to expression (1) above) to determine whether the PRS provides sufficient signal energy over an integration period for a reliable detection of the PRS at a particular allocated receiver bandwidth. Block 404 may further comprise comparing a duty cycle of a PRS (or combinations of T_{PRS} and N_{PRS}) and/or PRS_{OVH} to a threshold value to determine whether the PRS provides sufficient signal energy over an integration period. It should be understood, however, that these are merely examples of how an unsuitability of an operating band of a TPS for application of the TPS in performing a positioning operation may be identified, and that claimed subject matter is not limited in this respect.

Responsive to determination of an unsuitability of an operating frequency band of a TPS, block 404 may comprise initiating an alternative signal acquisition process. Here, a time of arrival of a signal acquired in the alternative action may be used in a positioning operation such as obtaining a position fix or location estimate. Following the alternative action initiated at block 404, a mobile device may return operation of a receiver to an original configuration at an allocated operational frequency band (e.g., by tuning a receiver to a 1.4 MHz band allocated to a receiver of a Cat M1 device).

In one example implementation, an alternative signal acquisition process initiated at block 404 may comprise operating a receiver of a mobile device at two or more non-overlapping frequency sub-bands within the operating frequency band of the TPS. For example, block 404 may initiate a frequency hopping operation to acquire the TPS. In this context, a “frequency hopping operation” as referred to herein means an operation for rapidly tuning an operational band of a receiver to different channels or portions of a transmission spectrum. For example, a Cat M1 mobile device with a receiver having an operational bandwidth of 1.4 MHz may perform frequency hopping by rapidly tuning a center frequency of the operational bandwidth to different channels or portions of an operational band of a PRS (e.g., 20.0 MHz as shown in FIG. 3). A system bandwidth of a mobile device receiver may be portioned into contiguous 1.4 MHz narrow sub-bands. In an implementation, the mobile device receiver may “hop” to a different narrow sub-band on signal subframes (e.g., PRS subframes) with a two symbol transition time. In an embodiment of a frequency hopping process, a receiver of the mobile device may initially tune to a center frequency band centered on the system bandwidth of the receiver. The receiver may then sequentially tune to 1.4 MHz narrow sub-bands above the center frequency, retune to the center frequency band, and then sequentially tune to 1.4 MHz narrow sub-bands below the center frequency. Measurements or observations of a TPS obtained at the different 1.4 MHz narrow sub-bands may be combined to improve signal to noise. According to an embodiment, measurements or observations of a TPS obtained at the different 1.4 MHz narrow sub-bands may be combined coherently or non-coherently. For example, measurements or observations of multiple PRS occasions by addition of channel energy response (CER) vectors. It should be understood, however, that this is merely an example of how a mobile device may perform a frequency hopping operation, and claimed subject matter is not limited in this respect.

As pointed out above, frequency hopping initiated at block 404 may enable a mobile device to mitigate an unsuitability of an operational band of a TPS affecting available signal energy for reliable acquisition and detection. For example, a mobile device receiver having a configured operational bandwidth that does not overlap with a transmission band of a TPS may employ frequency hopping to detect/integrate signal energy of the transmission band of the TPS. Also, if a duty cycle and transmission band of a TPS does not permit reliable detection of the TPS at an operation bandwidth of a mobile device, the mobile device may employ frequency hopping to detect signal energy in portions of the TPS at different frequencies. This may permit cancellation of noise that is uncorrelated in frequency. As discussed above, following obtaining RSTD measurements through frequency hopping initiated at block 404 (e.g., responsive to detection of an unsuitability of an operational band of a PRS for application to a positioning operation), a mobile device may return operation of a receiver to an original configuration at an allocated operational frequency band.

In an alternative implementation, block 404 may comprise initiating an alternative action to attempt acquiring a signal other than a particular TPS. For example, if block 404 determines that an operating frequency band of a particular PRS of a downlink signal is unsuitable for a positioning operation given an operating frequency band of a receiver, block 404 may initiate a process to acquire a signal other than the particular PRS. In one implementation, block 404 may comprise tuning a receiver to acquire a different signal in the downlink signal (other than the particular PRS) such as a CRS. For example, block 404 may tune a receiver of a mobile device to acquire CRS symbols at a particular frequency and symbol period in the downlink signal. In another implementation, block 404 may comprise tuning a receiver to acquire a different signal in the downlink signal such as a primary synchronization signal (PSS) or secondary synchronization signal (SSS) (see, e.g., 3GPP TS 36.211). Here, an LTE downlink signal may comprise an orthogonal frequency division multiplexed (OFDM) PSS and SSS at a 62 subcarrier center portion of the transmission band of the LTE downlink signal transmitted periodically on particular symbol periods. Such a PSS may be generated from a frequency domain Zadoff-Chu sequence and such an SSS may comprise an interleaved concatenation of two length-31 binary sequences. Block 404 may comprise tuning a receiver of a mobile device to the 62 subcarrier center portion to acquire such a PSS and/or SSS at symbol periods.

According to an embodiment, a mobile device may perform any one of several operations following acquisition of a TPS following an alternative acquisition process initiated at block 404. For example, a mobile device may measure or observe a time of arrival of the TPS based on acquisition of the TPS initiated at block 404. In another example, a mobile device may measure a time difference of arrival of the TPS and a second signal (e.g., a second TPS transmitted from a different transmitter), and report the time difference of arrival to a location server. In another example, a mobile device may estimate its location based, at least in part, on the aforementioned time of arrival of the TPS or timing difference of arrival and known locations of transmitters.

FIG. 4B is a flow diagram of a process to including an initiation of an alternative signal acquisition process according to a particular implementation of block 404. Block 450 may comprise an evaluation of parameters characterizing a TPS such as, for example, an evaluation of PRS bandwidth PRS_{BW}, configuration index I_{PRS}, cyclic prefix length, number of antenna ports, SFN initialization time, burst or pulse duration (N_{PRS}), muting pattern, and muting sequence periodicity (T_{REP}), as discussed above. Based, on an evaluation of parameters at block 450, diamond 452 may determine whether the TPS provides sufficient signal energy (to be acquired by a mobile device receiver having a particular operating bandwidth) for reliable positioning (e.g. for computing an accurate RSTD measurement). Block 456 may then apply an alternative signal acquisition process at block 454 if diamond 452 determines that the TPS does not provide sufficient signal energy.

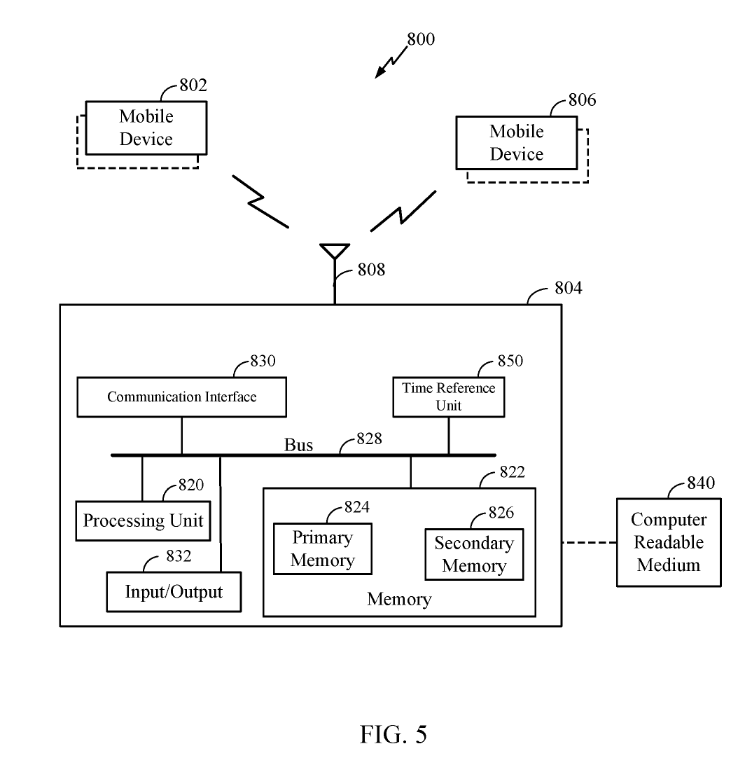

Subject matter shown in FIGS. 5, 6 and 7 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure within the meaning of 35 USC § 112(f) so that it is specifically intended that 35 USC § 112(f) not be implicated by use of the term “computing device,” “wireless station,” “wireless transceiver device,” “mobile device” and/or similar terms; however, if it is determined, for some reason not immediately apparent, that the foregoing understanding cannot stand and that 35 USC § 112(f) therefore, necessarily is implicated by the use of the term “computing device,” “wireless station,” “wireless transceiver device,” “mobile device” and/or similar terms, then, it is intended, pursuant to that statutory section, that corresponding structure, material and/or acts for performing one or more functions be understood and be interpreted to be described at least in FIGS. 4A and 4B, and corresponding text of the present disclosure.

FIG. 5 is a schematic diagram illustrating an example system 800 that may include one or more devices configurable to implement techniques or processes described above, for example, in connection with FIG. 1. System 800 may include, for example, a first device 802, a second device 804, and a third device 806, which may be operatively coupled together through a wireless communications network. In an aspect, first device 802 may comprise a mobile device as shown, for example. Second device 804 may comprise a node in a cellular/wireless communication network and third device 806 may comprise another mobile device, in an aspect. Also, in an aspect, devices 802, 804 and 806 may be included in a wireless communications network which may comprise one or more wireless access points, for example. However, claimed subject matter is not limited in scope in these respects. In certain particular implementations, device 804 may have features or aspects of nodes 102, 106 or 112 (e.g., implementing eNode B devices).

First device 802, second device 804 and third device 806, as shown in FIG. 5, may be representative of any device, appliance or machine that may be configurable to exchange data over a wireless communications network. By way of example but not limitation, any of first device 802, second device 804, or third device 806 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; wireless telecommunications access terminal; or any combination thereof. Any of the first, second, and third devices 802, 804, and 806, respectively, may comprise one or more of an access point or a mobile device in accordance with the examples described herein. In one particular example implementation, any of first device 802, second device 804, or third device 806 may comprise an IoT device or Cat M1 compatible device.

Similarly, a wireless communications network, as shown in FIG. 5, is representative of one or more communication links, processes, or resources configurable to support the exchange of data between at least two of first device 802, second device 804, and third device 806. By way of example but not limitation, a wireless communications network may include wireless or wired communication links, telephone or telecommunications systems (e.g., LTE), data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 806, there may be additional like devices operatively coupled to system 800.

It is recognized that all or part of the various devices and networks shown in FIG. 5, and the processes and methods as further described herein, may be implemented using or otherwise including hardware, firmware, software, or any combination thereof.

Thus, by way of example but not limitation, second device 804 may include at least one processing unit 820 that is operatively coupled to a memory 822 through a bus 828.

Processing unit 820 is representative of one or more circuits configurable to perform at least a portion of a data computing procedure or process. By way of example but not limitation, processing unit 820 may include one or more processors, controllers, microprocessors, microcontrollers, application specific integrated circuits, digital signal processors, programmable logic devices, field programmable gate arrays, and the like, or any combination thereof.

Memory 822 is representative of any data storage mechanism. Memory 822 may include, for example, a primary memory 824 or a secondary memory 826. Primary memory 824 may include, for example, a random access memory, read only memory, etc. While illustrated in this example as being separate from processing unit 820, it should be understood that all or part of primary memory 824 may be provided within or otherwise co-located/coupled with processing unit 820.

Secondary memory 826 may include, for example, the same or similar type of memory as primary memory or one or more data storage devices or systems, such as, for example, a disk drive, an optical disc drive, a tape drive, a solid state memory drive, etc. In certain implementations, secondary memory 826 may be operatively receptive of, or otherwise configurable to couple to, a computer-readable medium 840. Computer-readable medium 840 may include, for example, any non-transitory medium that can carry or make accessible data, code or instructions for one or more of the devices in system 800. Computer-readable medium 840 may also be referred to as a storage medium.

Second device 804 may include, for example, a communication interface 830 that provides for or otherwise supports the operative coupling of second device 804 to a wireless communications network at least through an antenna 808. By way of example but not limitation, communication interface 830 may include a network interface device or card, a modem, a router, a switch, a transceiver, and the like. In a particular implementation, communication interface 830 may comprise a wireless transmitter that is configured for transmission of a TPS such as a PRS. For example, a wireless transmitter of communication interface 830 may be configured for transmission of a PRS on a downlink signal having particular characteristics according to particular parameters such as bandwidth (BW), configuration index (I_{PRS}, which may then define offset (Δ_{PRS}) and periodicity (T_{PRS})), cyclic prefix length, number of antenna ports, SFN initialization time, burst or pulse duration (N_{PRS}), muting pattern, and muting sequence periodicity (T_{REP}) as discussed above. In another particular implementation, for example, processing unit 820 in combination with memory 822 may provide a controller capable of controlling transmission of a PRS transmitted through a transmitter of communication interface by, for example, controlling parameters such as bandwidth (BW), configuration index (I_{PRS}, which may then define offset (Δ_{PRS}) and periodicity (T_{PRS})), cyclic prefix length, number of antenna ports, SFN initialization time, burst or pulse duration (N_{PRS}), muting pattern, and muting sequence periodicity (T_{REP}) as discussed above.

Second device 804 may include, for example, an input/output device 832. Input/output device 832 is representative of one or more devices or features that may be configurable to accept or otherwise introduce human or machine inputs, or one or more devices or features that may be configurable to deliver or otherwise provide for human or machine outputs. By way of example but not limitation, input/output device 832 may include an operatively configured display, speaker, keyboard, mouse, trackball, touch screen, data port, etc.

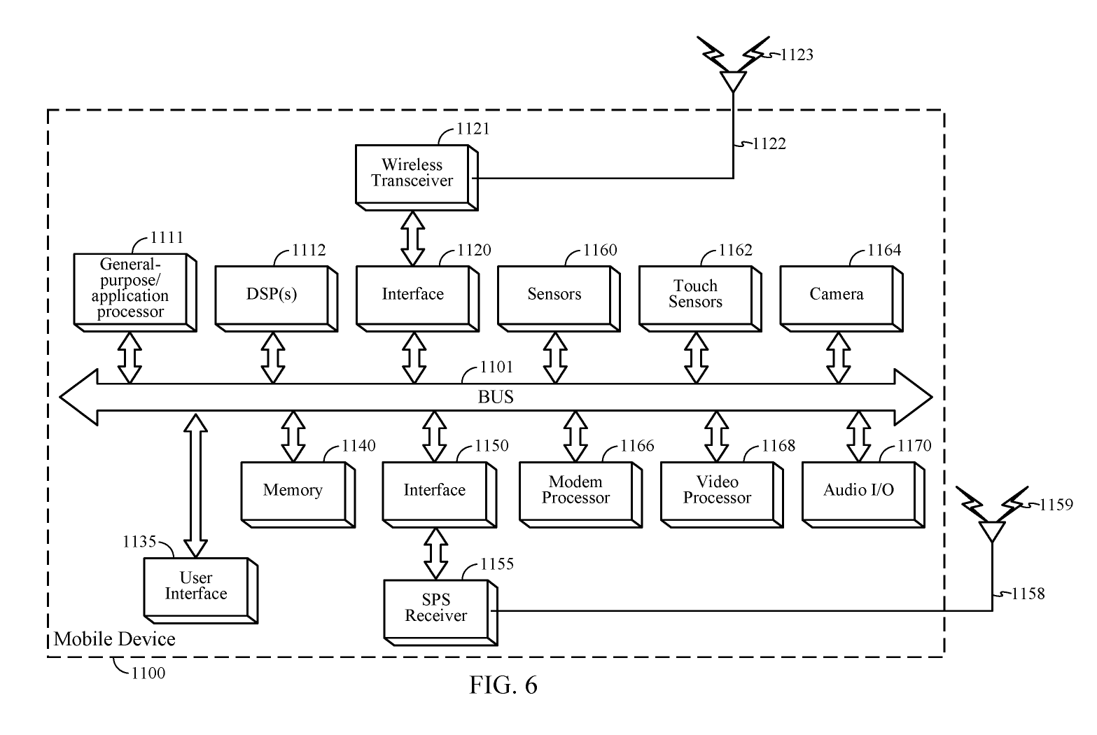

FIG. 6 is a schematic diagram of a mobile device according to an embodiment. Mobile device 100 (FIG. 1) may comprise one or more features of mobile device 1100 shown in FIG. 6. In one example implementation, mobile device 1100 may comprise a low-power “Internet of Things” (IoT) device having a receiver configured for processing LTE signals, and in particular, a PRS to facilitate positioning operations. In another example, implementation, mobile device 1100 may comprise a Cat M1 device employing a narrowband receiver (e.g., at wireless transceiver 1121 having an allocated receiver bandwidth of about 1.4 MHz) but capable of operating within an LTE carrier environment of up to a 20.0 MHz operational bandwidth.

Wireless transceiver 1121 may be capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to corresponding multiple wireless communication standards such as, for example, versions of IEEE Std. 802.11, CDMA, WCDMA, LTE, UMTS, GSM, AMPS, Zigbee and Bluetooth, just to name a few examples. In a particular implementation, wireless transceiver 1121 may receive and acquire a downlink signal comprising a terrestrial positioning signal such as a PRS. For example, wireless transceiver device may process an acquired terrestrial positioning signal sufficiently to enable detection of timing of the acquired terrestrial positioning signal. In another example implementation, wireless transceiver 1121 may comprise a receiver that is configured to receive communications over a narrow operational band (e.g., 1.4 MHz as a Cat M1 device), and configurable to implement a frequency hopping operation as initiated at block 404 described above.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1100. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals (e.g., signals acquired from wireless transceiver 1121) for use in performing positioning operations may be performed in memory 1140 or registers (not shown). As such, general-purpose processor(s) 1111, memory 1140, DSP(s) 1112 and/or specialized processors may provide a location engine for use in processing measurements to estimate a location of mobile device 1100. In a particular implementation, all or portions of actions or operations set forth at blocks 220 and 222 may be executed by general-purpose processor(s) 1111 or DSP(s) 1112 based on machine-readable instructions stored in memory 1140. For example general-purpose processor(s) 1111 or DSP(s) 1112 may process a downlink signal acquired by wireless transceiver 1121 to, for example, perform one or more positioning operations (e.g., using OTDOA techniques based on acquisition of one or more PRS’) including performing actions shown in blocks 402 and 404 discussed above.

Also shown in FIG. 6, digital signal processor(s) (DSP(s)) 1112 and general-purpose processor(s) may be connected to memory 1140 through bus 1101. A particular bus interface (not shown) may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein including, for example, actions shown in blocks 402, 404 and 406 discussed above.

Also shown in FIG. 6, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

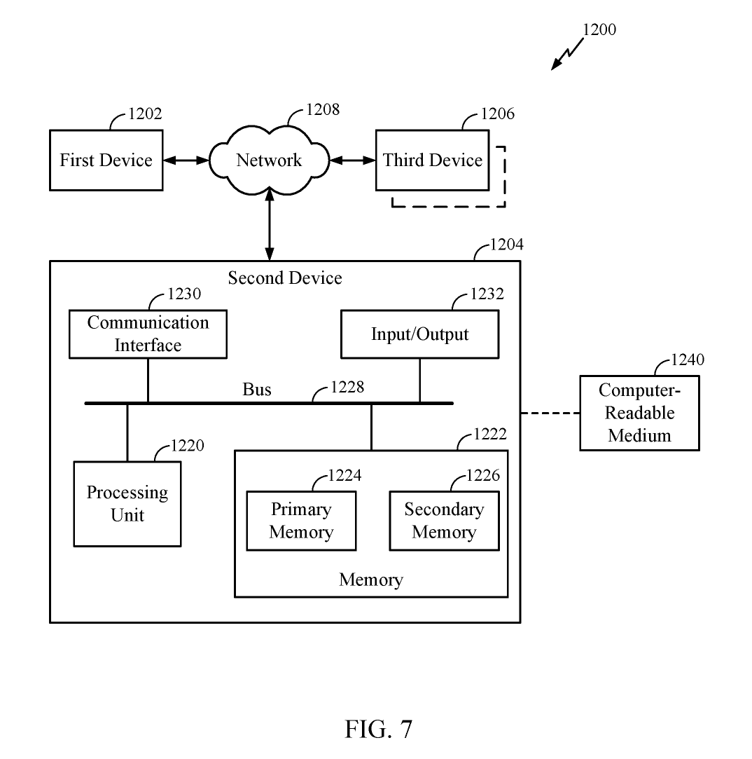

FIG. 7 is a schematic diagram illustrating an example system 1200 that may include one or more devices configurable to implement techniques or processes described above. System 1200 may include, for example, a first device 1202, a second device 1204, and a third device 1206, which may be operatively coupled together through a wireless communications network 1208. In an aspect, first device 1202 may comprise a server (e.g., E-SMLC 114) capable of providing positioning assistance data such as, for example, OTDOA positioning assistance data including indications of which frequency channels are carrying PRSs, the center and size of search window for PRSs, bandwidth (BW), configuration index (I_{PRS}, which may then define offset (Δ_{PRS}) and periodicity (T_{PRS})), cyclic prefix length, number of antenna ports, SFN initialization time, burst or pulse duration (N_{PRS}), muting pattern, and muting sequence periodicity (T_{REP}), locations of beacon transmitters, timing relationship among beacon transmitters, just to provide a few examples. Also, in an aspect, wireless communications network 1208 may comprise one or more wireless access points, for example. However, claimed subject matter is not limited in scope in these respects.

First device 1202, second device 1204 and third device 1206 may be representative of any device, appliance or machine (e.g., such as MMEs 104, mobile device 100, E-SMLC 114 or node 102, 106 or 112). For example, E-SMLC 114 may transmit messages to node 102, 106 or 112 to configure node 102, 106 or 102. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, wireless communications network 1208, may be representative of one or more communication links, processes, or resources configurable to support the exchange of data between at least two of first device 1202, second device 1204, and third device 1206. By way of example but not limitation, wireless communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220.

In a particular implementation, a digital map of an indoor area may be stored in a particular format in memory 1222. Processing unit 1220 may execute instructions to processes the stored digital map to identify and classify component areas bounded by a perimeter of structures indicated in the digital map.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1030 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

As used herein, the terms “mobile device” and “user equipment” (UE) are used synonymously to refer to a device that may from time to time have a location that changes. The changes in location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband CDMA (WCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and WCDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. 4G Long Term Evolution (LTE) and 5G or New Radio (NR) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (CDMA) cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method at a mobile device comprising:
obtaining, from one or more messages received from a location server, assistance data indicating at least an operating frequency band of a terrestrial positioning signal (TPS); and
acquiring the TPS, at the mobile device, by operating a receiver of the mobile device at two or more non-overlapping frequency sub-bands within the operating frequency band of the TPS in response to a determination that the operating frequency band of the TPS is unsuitable for application of the TPS in performing a positioning operation, wherein the receiver of the mobile device having an operating frequency band narrower than the operating frequency band of the TPS.

2. (canceled)

3. The method of claim 1, wherein the operating the receiver of the mobile device at two or more non-overlapping frequency sub-bands within the operating frequency band of the TPS further comprises initiating a frequency hopping operation at the receiver of the mobile device to acquire the TPS in response to the determination that the operating frequency band is unsuitable for the application of the TPS in performing the positioning operation.

4. The method of claim 1, and further comprising determining that the operating frequency band of the TPS is unsuitable for application of the TPS in performing the positioning operation based, at least in part, on an absence of overlap between the operating frequency band of the receiver and the operating frequency band of the TPS.

5. The method of claim 1, wherein the TPS comprises a positioning reference signal (PRS), a cell-specific reference signal (CRS) or a secondary synchronization signal (SSS), or a combination thereof.

6. The method of claim 5, wherein the positioning assistance data further comprises one or more parameters indicative of the PRS received at the receiver of the mobile device, and wherein the method further comprises determining that the operating frequency band of the TPS is unsuitable for application of the TPS in performing the positioning operation based, at least in part, on the one or more parameters.

7. The method of claim 6, wherein the one or more parameters indicative of the PRS received at the receiver of the mobile device comprise periodicity of the PRS or a pulse duration of the PRS, or a combination thereof.

8. The method of claim 1, and further comprising returning operation of the receiver to an original configuration at an allocated operating frequency band following obtaining one or more measurements based, at least in part, on acquisitions of the TPS using the alternative signal acquisition process.

9. The method of claim 1, wherein the TPS comprises a positioning reference signal (PRS) in a downlink signal, and wherein initiating the alternative signal acquisition process further comprises initiating a process to acquire a cell-specific reference signal (CRS) in the downlink signal or a synchronization signal in the downlink signal, or a combination thereof.

10. The method of claim 9, wherein the synchronization signal comprises a primary synchronization signal or a secondary synchronization signal.

11. The method of claim 1, and further comprising determining that the operating frequency band of the TPS is unsuitable for application of the TPS in performing the positioning operation based, at least in part, on a comparison of the operating frequency band of the receiver of the mobile device and the operating frequency band of the TPS.

12. The method of claim 11, wherein the operating frequency band of the TPS is selected from 10 MHz or 20 MHz, and wherein the operating frequency band of the receiver is 1.4 MHz.

13. The method of claim 1, wherein the mobile device comprises a Cat M1 device operating in a long-term evolution (LTE) network.

14. A mobile device comprising:
a receiver; and
one or more processors coupled to the receiver and configured to:
obtain, from one or more messages received at the receiver from a location server, assistance data indicating at least an operating frequency band of a terrestrial positioning signal (TPS); and
acquire the TPS by operating the receiver at two or more non-overlapping frequency sub-bands within the operating frequency band of the TPS in response to a determination that the operating frequency band of the TPS is unsuitable for application of the TPS in performing a positioning operation, wherein the receiver having an operating frequency band narrower than the operating frequency band of the TPS.

15. (canceled)

16. The mobile device of claim 14, wherein the operating the receiver at two or more non-overlapping frequency sub-bands within the operating frequency band of the TPS further comprises a frequency hopping operation at the receiver of the mobile device.

17. The mobile device of claim 14, wherein one or more processors are further configured to determine that the operating frequency band of the TPS is unsuitable for application of the TPS in performing the positioning operation based, at least in part, on an absence of overlap between the operating frequency band of the receiver and the operating frequency band of the TPS.

18. The mobile device of claim 14, wherein the TPS comprises a positioning reference signal (PRS), a cell-specific reference signal (CRS) or a secondary synchronization signal (SSS), or a combination thereof.

19. The mobile device of claim 18, wherein the positioning assistance data further comprises one or more parameters indicative of the PRS received at the receiver, and wherein the one or more processors are further configured to determine that the operating frequency band of the TPS is unsuitable for application of the TPS in performing the positioning operation based, at least in part, on the one or more parameters.

20. The mobile device of claim 19, wherein the one or more parameters indicative of the PRS received at the receiver of the mobile device comprise periodicity of the PRS or a pulse duration of the PRS, or a combination thereof.

21. The mobile device of claim 14, wherein the one or more processors are further configured to return operation of the receiver to an original configuration at an allocated operating frequency band following obtaining one or more measurements based, at least in part, on acquisitions of the TPS using the alternative signal acquisition process.

22. The mobile device of claim 14, wherein the TPS comprises a positioning reference signal (PRS) in a downlink signal, and wherein initiating the alternative signal acquisition process further comprises initiating a process to acquire a cell-specific reference signal (CRS) in the downlink signal or a synchronization signal in the downlink signal, or a combination thereof.

23. The mobile device of claim 22, wherein the synchronization signal comprises a primary synchronization signal or a secondary synchronization signal.

24. The mobile device of claim 14, wherein the one or more processors are further configured to determine that the operating frequency band of the TPS is unsuitable for application of the TPS in performing the positioning operation based, at least in part, on a comparison of the operating frequency band of the receiver of the mobile device and the operating frequency band of the TPS.

25. The mobile device of claim 24, wherein the operating frequency band of the TPS is selected from 10 MHz or 20 MHz, and wherein the operating frequency band of the receiver is 1.4 MHz.

26. The mobile device of claim 14, wherein the mobile device comprises a Cat M1 device operating in a long-term evolution (LTE) network.

27. A non-transitory storage medium comprising computer-readable instructions stored thereon which are executable by a processor of a mobile device to:
obtain, from one or more messages received from a location server, assistance data indicating at least an operating frequency band of a terrestrial positioning signal (TPS); and
acquire the TPS, at the mobile device, by operating a receiver of the mobile device at two or more non-overlapping frequency sub-bands within the operating frequency band of the TPS in response to a determination that the operating frequency band of the TPS is unsuitable for application of the TPS in performing a positioning operation, wherein the receiver of the mobile device having an operating frequency band narrower than the operating frequency band of the TPS.

28. (canceled)

29. A mobile device comprising:
means for receiving one or more messages from a location server comprising assistance data indicating at least an operating frequency band of a terrestrial positioning signal (TPS); and
means for acquiring the TPS, at the mobile device, by means for operating a receiver of the mobile device at two or more non-overlapping frequency sub-bands within the operating frequency band of the TPS in response to a determination that the operating frequency band of the TPS is unsuitable for application of the TPS in performing a positioning operation, wherein the receiver of the mobile device having an operating frequency band narrower than the operating frequency band of the TPS.

30. The mobile device of claim 29, wherein the means for operating the receiver of the mobile device at two or more non-overlapping frequency sub-bands within the operating frequency band of the TPS further comprises means for initiating a frequency hopping operation at the receiver of the mobile device to acquire the TPS in response to the determination that the operating frequency band is unsuitable for the application of the TPS in performing the positioning operation.
